(19) United States
(12) Patent Application Publication
(10) Pub. No.: US 2013/0037299 A1
(43) Pub. Date: Feb. 14, 2013

(54) Stripline RF Transmission Cable

(71) Applicant: Frank A. Harwath, Naperville, IL (US)

(72) Inventor: Frank A. Harwath, Naperville, IL (US)

(73) Assignee: ANDREW LLC, Hickory, NC (US)

(21) Appl. No.: 13/208,443

(22) Filed: Aug. 12, 2011

(51) Int. Cl. H01B 7/08; H01R 43/00

(52) U.S. Cl. 174/115; 29/825

(57) ABSTRACT

A stripline RF transmission cable has a flat inner conductor surrounded by a dielectric layer that is surrounded by an outer conductor. The outer conductor has a flat top section and a flat bottom section which transition to a pair of edge sections that interconnect the top section with the bottom section. The top section, bottom section and the inner conductor may be provided with generally equal widths.

### BACKGROUND OF THE INVENTION

RF Transmission systems are used to transmit RF signals from point to point, for example from an antenna to a transceiver or the like. Common forms of RF transmission systems include coaxial cables and striplines.

Prior coaxial cables typically have a coaxial configuration with a circular outer conductor evenly spaced away from a circular inner conductor by a dielectric support such as polyethylene foam or the like. The electrical properties of the dielectric support and spacing between the inner and outer conductor define a characteristic impedance of the coaxial cable. Circumferential uniformity of the spacing between the inner and outer conductor prevents introduction of impedance discontinuities into the coaxial cable that would otherwise degrade electrical performance.

An industry standard characteristic impedance is 50 ohms. Coaxial cables configured for 50 ohm characteristic impedance generally have an increased inner conductor diameter compared to higher characteristic impedance coaxial cables such that the metal inner conductor material cost is a significant portion of the entire cost of the resulting coaxial cable. To minimize material costs, the inner and outer conductors may be configured as thin metal layers for which structural support is then provided by less expensive materials. For example, commonly owned U.S. Pat. No. 6,800,809, titled “Coaxial Cable and Method of Making Same”, by Moe et al, issued Oct. 5, 2004, hereby incorporated by reference in the entirety, discloses a coaxial cable structure wherein the inner conductor is formed by applying a metallic strip around a cylindrical filler and support structure comprising a cylindrical plastic rod support structure with a foamed dielectric layer there around. The resulting inner conductor structure has significant materials cost and weight savings compared to coaxial cables utilizing solid metal inner conductors. However, these structures incur additional manufacturing costs, due to the multiple additional manufacturing steps required to sequentially apply each layer of the structure.

One limitation with respect to metal conductors and/or structural supports replacing solid metal conductors is bend radius. Generally, a larger diameter coaxial cable will have a reduced bend radius before the coaxial cable is distorted and/or buckled by bending. In particular, structures may buckle and/or be displaced out of coaxial alignment by cable bending in excess of the allowed bend radius, resulting in cable collapse and/or degraded electrical performance.

A stripline is a flat conductor sandwiched between parallel interconnected ground planes. Striplines have the advantage of being non-dispersive and may be utilized for transmitting high frequency RF signals. Striplines may be cost effectively generated using printed circuit board technology or the like. However, striplines may be expensive to manufacture in longer lengths/larger dimensions. Further, where a solid stacked printed circuit board type stripline structure is not utilized, the conductor sandwich is generally not self supporting and/or aligning, compared to a coaxial cable, and as such may require significant additional support/reinforcing structure.

Competition within the RF transmission line industry has focused attention upon reducing materials and manufacturing costs, electrical characteristic uniformity, defect reduction and overall improved manufacturing quality control.

Therefore, it is an object of the invention to provide a coaxial cable and method of manufacture that overcomes deficiencies in such prior art.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a schematic isometric view of an exemplary transmission line, with layers of the conductors, dielectric spacer and outer jacket stripped back.

FIG. 2 is a schematic end view of the transmission line of FIG. 1.

FIG. 3 is a schematic isometric view demonstrating a bend radius of the transmission line of FIG. 1.

FIG. 4 is a schematic isometric view of an alternative transmission line, with layers of the conductors, dielectric spacer and outer jacket stripped back.

### DETAILED DESCRIPTION

The inventor has recognized that the prior accepted coaxial cable design paradigm of concentric circular cross section design geometries results in unnecessarily large coaxial cables with reduced bend radius, excess metal material costs and/or significant additional manufacturing process requirements.

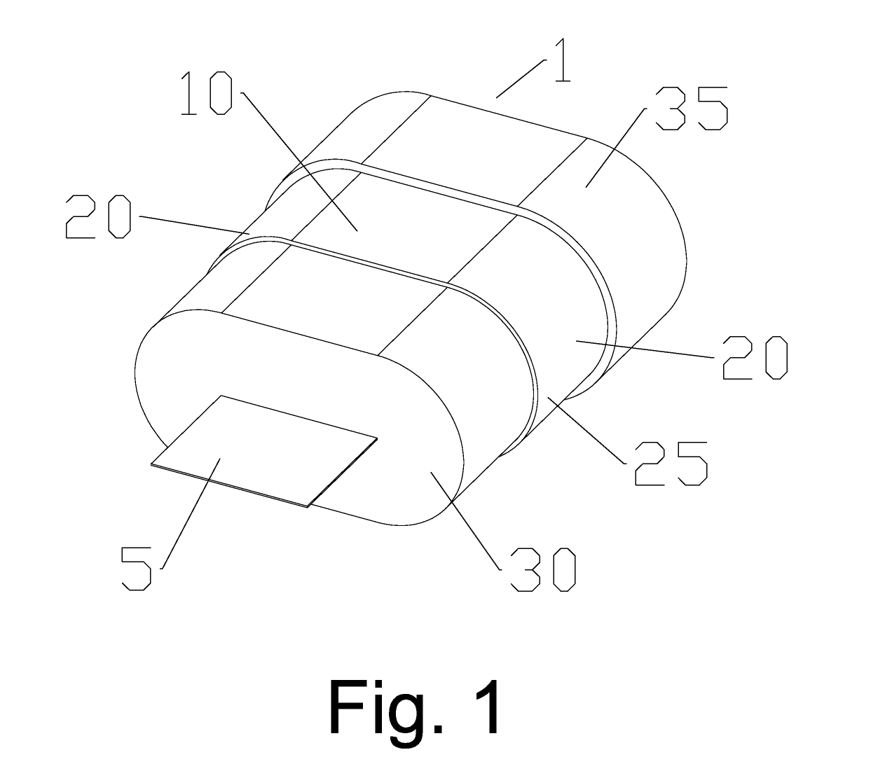

An exemplary stripline RF transmission cable 1 is demonstrated in FIGS. 1-3. As best shown in FIG. 1, the inner conductor 5 of the cable 1 is a flat metallic strip. A top section 10 and a bottom section 15 of the outer conductor 25 are aligned parallel to the inner conductor 5 with widths equal to the inner conductor width. The top and bottom sections 10, 15 transition at each side into convex edge sections 20. Thus, the circumference of the inner conductor 5 is entirely sealed within an outer conductor 25 comprising the top section 10, bottom section 15 and edge sections 20.

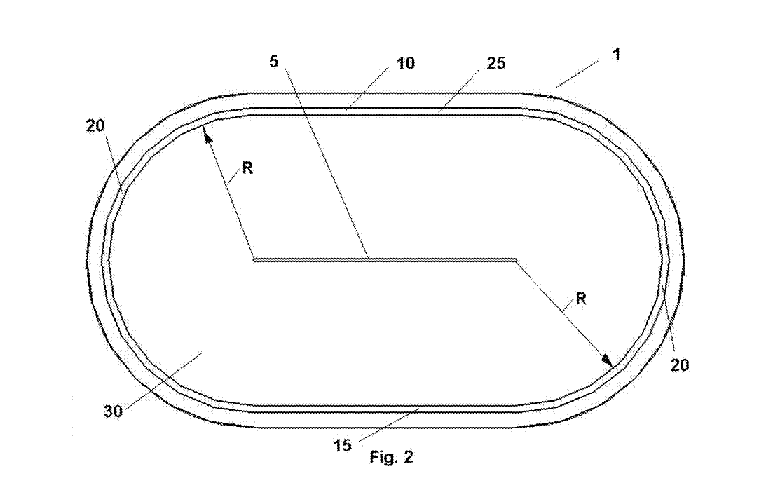

The dimensions/curvature of the edge sections 20 may be selected, for example, for ease of manufacture. Preferably, the edge sections 20 and any transition thereto from the top and bottom sections 10, 15 is generally smooth, without sharp angles or edges. As best shown in FIG. 2, the edge sections 20 may be provided as circular arcs with an arc radius R, with respect to each side of the inner conductor 5, equivalent to the spacing between each of the top and bottom sections 10, 15 and the inner conductor 5, resulting in a generally equal spacing between any point on the circumference of the inner conductor 5 and the nearest point of the outer conductor 25, minimizing outer conductor material requirements.

The desired spacing between the inner conductor 5 and the outer conductor 25 may be obtained with high levels of precision via application of a uniformly dimensioned spacer structure with dielectric properties, referred to as the dielectric layer 30, and then surrounding the dielectric layer 30 with the outer conductor 25. Thereby, the cable 1 may be provided in essentially unlimited continuous lengths with a uniform cross section at any point along the cable 1.

The inner conductor 5 metallic strip may be formed as solid rolled metal material such as copper, aluminum, steel or the like. For additional strength and/or cost efficiency, the inner conductor 5 may be provided as copper coated aluminum or copper coated steel.

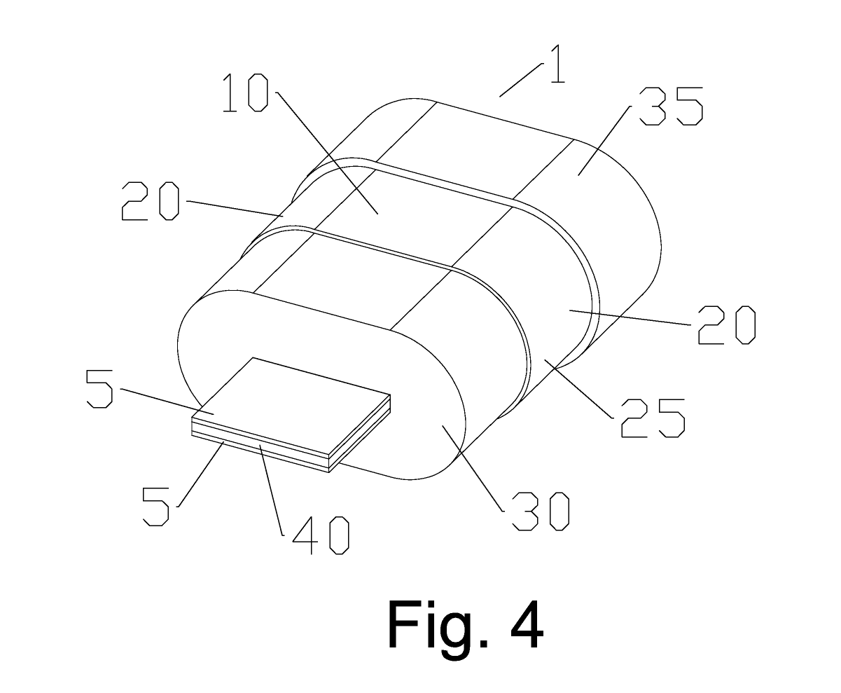

Alternatively, the inner conductor 5 may be provided as a substrate 40 such as a polymer and/or fiber strip that is metal coated or metalized, for example as shown in FIG. 4. One skilled in the art will appreciate that such alternative inner conductor configurations may enable further metal material reductions and/or an enhanced strength characteristic enabling a corresponding reduction of the outer conductor strength characteristics.

The dielectric layer 30 may be applied as a continuous wall of plastic dielectric material around the outer surface of the inner conductor 5. The dielectric layer 30 may be a low loss dielectric formed of a suitable plastic such as polyethylene, polypropylene, and/or polystyrene. The dielectric material may be of an expanded cellular foam composition, and in particular, a closed cell foam composition for resistance to moisture transmission. Any cells of the cellular foam composition may be uniform in size. One suitable foam dielectric material is an expanded high density polyethylene polymer as disclosed in commonly owned U.S. Pat. No. 4,104,481, titled “Coaxial Cable with Improved Properties and Process of Making Same” by Wilkenloh et al, issued Aug. 1, 1978, hereby incorporated by reference in the entirety. Additionally, expanded blends of high and low density polyethylene may be applied as the foam dielectric.

Although the dielectric layer 30 generally consists of a uniform layer of foam material, the dielectric layer 30 can have a gradient or graduated density such that the density of the dielectric increases radially from the inner conductor 5 to the outer diameter of the dielectric layer 30, either in a continuous or a step-wise fashion. Alternatively, the dielectric layer 30 may be applied in a sandwich configuration as two separate layers, one applied to each side of the inner conductor 5.

The dielectric layer 30 may be bonded to the inner conductor 5 by a thin layer of adhesive. Additionally, a thin solid polymer layer and another thin adhesive layer may be present, protecting the outer surface of the inner conductor 5 for example as it is collected on reels during cable manufacture processing.

The outer conductor 25 is electrically continuous, entirely surrounding the circumference of the dielectric layer 30 to eliminate radiation and/or entry of interfering electrical signals. The outer conductor 25 may be a solid material such as aluminum or copper material sealed around the dielectric layer as a contiguous portion by seam welding or the like. Alternatively, helical wrapped and/or overlapping folded configurations utilizing, for example, metal foil and/or braided type outer conductor 25 may also be utilized.

If desired, a protective jacket 35 of polymer materials such as polyethylene, polyvinyl chloride, polyurethane and/or rubbers may be applied to the outer diameter of the outer conductor. The jacket 35 may comprise laminated multiple jacket layers to improve toughness, strippability, burn resistance, the reduction of smoke generation, ultraviolet and weatherability resistance, protection against rodent gnaw through, strength resistance, chemical resistance and/or cut-through resistance.

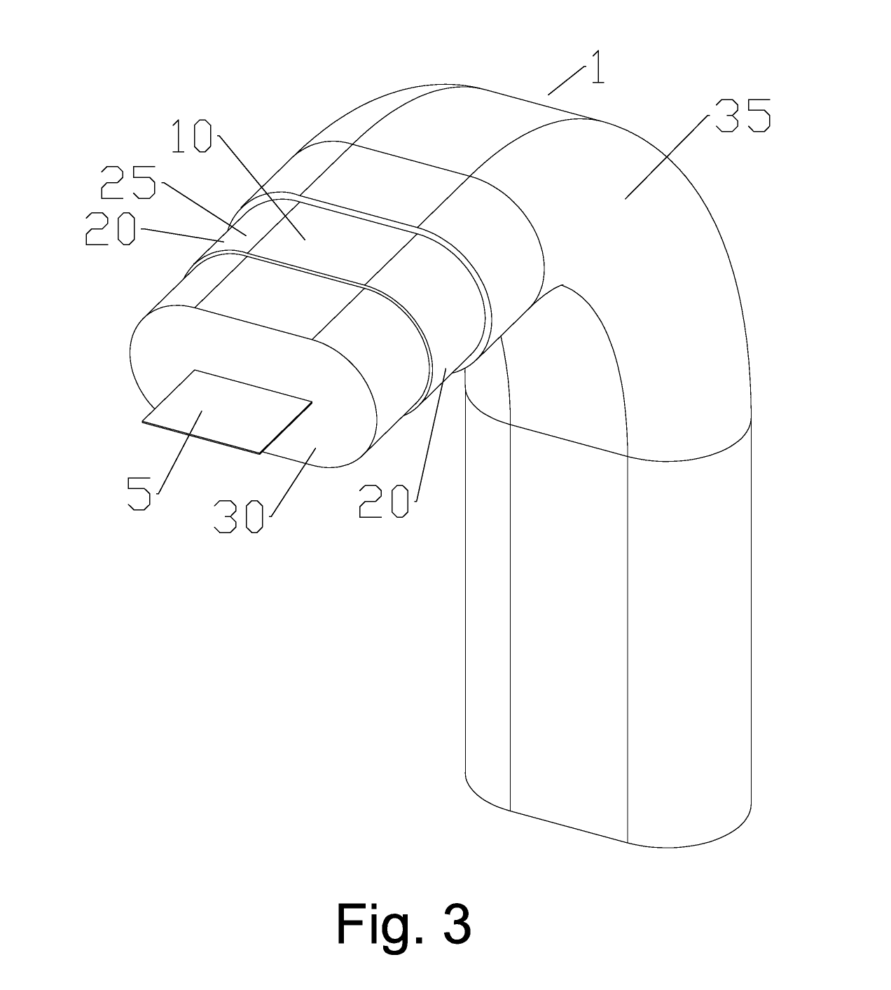

The flattened characteristic of the cable 1 has inherent bend radius advantages. As best shown in FIG. 3, the bend radius of the cable perpendicular to the horizontal plane of the inner conductor 5 is reduced compared to a conventional coaxial cable of equivalent materials dimensioned for the same characteristic impedance. Since the cable thickness between the top section 10 and the bottom section 15 is thinner than the diameter of a comparable coaxial cable, distortion or buckling of the outer conductor 25 is less likely at a given bend radius. A tighter bend radius also improves warehousing and transport aspects of the cable 1, as the cable 1 may be packaged more efficiently, for example provided coiled upon smaller diameter spool cores which require less overall space.

One skilled in the art will appreciate that the cable 1 has numerous advantages over a conventional circular cross section coaxial cable. Because the desired inner conductor surface area is obtained without applying a solid or hollow tubular inner conductor, a metal material reduction of one half or more may be obtained. Alternatively, because complex inner conductor structures which attempt to substitute the solid cylindrical inner conductor with a metal coated inner conductor structure are eliminated, required manufacturing process steps are reduced. Further, the flat inner conductor 5 configuration is particularly well suited for cable termination upon/interconnection with planar termination surfaces such as printed circuit boards and the like.

Table of Parts

| | |
|---|---|
| 1 | cable |
| 5 | inner conductor |
| 10 | top section |
| 15 | bottom section |
| 20 | edge section |
| 25 | outer conductor |
| 30 | dielectric layer |
| 35 | jacket |
| 40 | substrate |

Where in the foregoing description reference has been made to ratios, integers or components having known equivalents then such equivalents are herein incorporated as if individually set forth.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus, methods, and illustrative examples shown and described. Accordingly, departures may be made from such details without departure from the spirit or scope of applicant's general inventive concept. Further, it is to be appreciated that improvements and/or modifications may be made thereto without departing from the scope or spirit of the present invention as defined by the following claims.

We claim:

1. A stripline RF transmission cable, comprising:
a flat inner conductor surrounded by a dielectric layer; and
an outer conductor surrounding the dielectric layer;
the outer conductor provided with a flat top section and a flat bottom section; the top section and the bottom section transitioning to a pair of edge sections which interconnect the top section with the bottom section; the top section, the bottom section and the inner conductor provided with a generally equal width.

2. The cable of claim 1, further including a jacket of polymer material surrounding an outer diameter of the outer conductor.

3. The cable of claim 1, wherein the edge sections are convex.

4. The cable of claim 1, wherein the edge sections are circular arcs with an arc radius, the arc radius generally equivalent to a spacing between the inner conductor and each of the top section and the bottom section.

5. The cable of claim 1, wherein the inner conductor is one of copper, aluminum, copper coated steel and copper coated aluminum.

6. The cable of claim 1, wherein the outer conductor is a helical wrap.

7. The cable of claim 1, wherein the outer conductor is a contiguous portion.

8. The cable of claim 1, wherein the dielectric layer is a contiguous portion.

9. The cable of claim 1, wherein the dielectric layer is a plastic foam material.

10. The cable of claim 1, wherein the inner conductor is a metal coated or metalized polymer strip.

11. A method for manufacturing a stripline RF transmission cable, comprising the steps of:
providing a flat inner conductor surrounded by a dielectric layer; and
surrounding the dielectric layer with an outer conductor;
the outer conductor provided with a flat top section and a flat bottom section; the top section and the bottom section transitioning to a pair of edge sections which interconnect the top section with the bottom section; the top section, bottom section and the inner conductor provided with a generally equal width.

12. The method of claim 11, wherein the edge sections are convex.

13. The method of claim 11, wherein the edge sections are circular arcs with an arc radius, the arc radius generally equivalent to a spacing between the inner conductor and each of the top section and the bottom section.

14. The method of claim 11, wherein the outer conductor is seam welded around the dielectric layer.

15. The method of claim 11, wherein the outer conductor is helically wrapped around the dielectric layer.

16. The method of claim 11, further including the step of surrounding an outer diameter of the outer conductor with a jacket of polymer material.

17. The method of claim 11, wherein the inner conductor is copper, copper coated aluminum or copper coated steel.

18. The method of claim 11, wherein the inner conductor is a metallic coated or metalized substrate.

19. A stripline RF transmission cable, comprising:
a. a flat inner conductor,
b. a tubular dielectric layer,
c. a tubular outer conductor, and
d. a tubular jacket;
the dielectric layer surrounding the flat inner conductor;
the outer conductor surrounding the dielectric layer;
the outer conductor provided with a flat top section and a flat bottom section;
the top section and the bottom section transitioning to a pair of edge sections which interconnect the top section with the bottom section;
the jacket surrounding the outer conductor;
the inner conductor, the dielectric layer, the outer conductor and the jacket provided with a uniform cross section along a length of the cable.

20. The cable of claim 19, wherein the edge sections are convex.
